(19) United States
(12) Patent Application Publication
(10) Pub. No.: US 2007/0080895 A1
(43) Pub. Date: Apr. 12, 2007

(54) PLASMA DISPLAY APPARATUS AND METHOD OF DRIVING THE SAME

(76) Inventor: Seonghak Moon, Seoul (KR)

Correspondence Address: FLESHNER & KIM, LLP, P.O. BOX 221200, CHANTILLY, VA, 20153, US

(21) Appl. No.: 11/538,090

(22) Filed: Oct. 3, 2006

(30) Foreign Application Priority Data
Oct. 4, 2005 (KR) 10-2005-0092997

(51) Int. Cl. G09G 3/28

(52) U.S. Cl. 345/60

(57) ABSTRACT

A plasma display apparatus and a method of driving the same are disclosed. The plasma display apparatus includes a plasma display panel including an address electrode, an address electrode driver, and an electrode group selection unit. The address electrode driver generates an address pulse supplied to a plurality of address electrode groups each comprising a plurality of address electrodes through one output terminal. The electrode group selection unit supplies the address pulse generated by the address electrode driver to the plurality of address electrode groups.

This Nonprovisional application claims priority under 35 U.S.C. §119(a) on Patent Application No. 10-2005-0092997 filed in Korea on Oct. 4, 2005 the entire contents of which are hereby incorporated by reference.

### BACKGROUND

1. Field

This document relates to a display apparatus, and more particularly, to a plasma display apparatus and a method of driving the same.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs forms unit discharge cell or discharge cells. Each of discharge cells is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultraviolet light, which thereby causes phosphors formed between the barrier ribs to emit light, thus displaying an image. Since the plasma display panel can be manufactured to be thin and light, it has attracted attention as a next generation display device.

FIG. 1 illustrates a driving waveform of a general plasma display apparatus.

As illustrated in FIG. 1, the plasma display apparatus is driven by dividing each of subfields into a reset period for initializing all discharge cells, an address period for selecting a cell to be discharged, a sustain period for maintaining a discharge of the selected discharge cell, and an erase period for erasing wall charges within the discharge cell.

The reset period is further divided into a setup period and a set-down period. During the setup period, a rising pulse (Ramp-up) is simultaneously supplied to all scan electrodes Y1 to Yn, thereby generating a weak dark discharge (i.e., a setup discharge) within the discharge cells of the whole screen. This results in wall charges of a positive polarity being accumulated on address electrodes X1 to Xm and sustain electrodes Z1 to Zn, and wall charges of a negative polarity being accumulated on the scan electrodes Y1 to Yn.

During the set-down period, a falling pulse (Ramp-down), which falls from a positive voltage lower than a peak voltage of the rising pulse (Ramp-up) to a given voltage lower than a ground level voltage GND, is supplied to the scan electrodes Y1 to Yn, thereby generating a weak erase discharge (i.e., a set-down discharge) within the discharge cells. Furthermore, the remaining wall charges are uniform inside the cells to the extent that the address discharge can be stably performed.

During the address period, a scan pulse (Scan) of a negative polarity is sequentially supplied to the scan electrodes Y1 to Yn and, at the same time, an address pulse (Data) of a positive polarity is supplied to the address electrodes X1 to Xm in synchronization with the scan pulse. As the voltage difference between the scan pulse (Scan) and the address pulse (Data) is added to the wall voltage generated during the reset period, the address discharge is generated within the discharge cells to which the address pulse is supplied.

Wall charges are formed inside the cells selected by performing the address discharge such that when a sustain voltage Vs is supplied, a discharge occurs. A positive bias voltage Vzb is supplied to the sustain electrodes Z1 to Zn during the set-down period and the address period so that an erroneous discharge does not occur between the sustain electrodes Z1 to Zn and the scan electrodes Y1 to Yn by reducing the voltage difference between the sustain electrodes Z1 to Zn and the scan electrodes Y1 to Yn.

During the sustain period, a sustain pulse (sus) is alternately supplied to the scan electrodes Y1 to Yn and the sustain electrodes Z1 to Zn. As the wall voltage within the cells selected by performing the address discharge is added to the sustain pulse (sus), every time the sustain pulse is applied, a sustain discharge, i.e., a display discharge is generated in the cells selected during the address period.

Finally, during the erase period (i.e., after the sustain discharge is completed), an erase pulse (Ramp-ers) having a small pulse width and a low voltage level is supplied to the sustain electrodes Z1 to Zn to erase the remaining wall charges within the cells of the whole screen.

FIG. 2 illustrates the configuration of a related art plasma display apparatus.

The plasma display apparatus illustrated in FIG. 2 supplies the corresponding pulses to the scan electrodes Y1 to Yn, the sustain electrodes Z1 to Zn and the address electrodes X1 to Xm during the address period and the sustain period.

During the address period which follows the reset period, a second switch 213-1 of a first scan driver 210-1 and a first scanning switch 220 are turned on, thereby supplying the scan pulse with a negative voltage −Vy to the first scan electrode Y1.

Further, a first data driver DD1 to an s-th data driver DDs simultaneously supply the address pulse to the address electrodes X1 to Xm in synchronization with the scan pulse supplied to the first scan electrode Y1.

In other words, a first data switch S1 or a second data switch S2 of an address pulse supply unit APP of each data driver operates, thereby supplying the address pulse. Accordingly, a data voltage (i.e., +Vd or 0V) is supplied to the address electrodes X1 to Xm, thereby selecting the cell to be turned on in the cells located on the first scan electrode Y1.

The above-described processes sequentially perform on all the scan electrodes Y1 to Yn.

Further, a bias switch 270 is turned on such that a positive bias voltage Vzb is supplied to the sustain electrode Z1 to Zn.

During the sustain period which follows the address period, a first sustain switch 240, the second switches 213-1 to 213-n of the scan drivers 210-1 to 210-n, and a second ground switch 260 are turned on.

As a result, a loop passing through the first sustain switch 240, the second switches 213-1 to 213-n of the scan drivers 210-1 to 210-n, the scan electrodes Y1 to Yn, the sustain electrodes Z1 to Zn, and the second ground switch 260 is formed such that a first sustain voltage (+Vsy) is supplied to the scan electrodes Y1 to Yn.

Next, a second sustain switch 250, the first switches 211-1 to 211-n of the scan drivers 210-1 to 210-n, and a first ground switch 230 are turned on.

As a result, a loop passing through the sustain electrodes Z1 to Zn, the scan electrodes Y1 to Yn, the fist switches 211-1 to 211-n of the scan drivers 210-1 to 210-n, and the first ground switch 230 is formed such that a second sustain voltage (+Vsz) is supplied to the sustain electrodes Z1 to Zn.

The first sustain voltage (+Vsy) and the second sustain voltage (+Vsz) are alternately supplied to the scan electrodes Y1 to Yn and the sustain electrodes Z1 to Zn, thereby generating the sustain discharge in the cell selected during the address period.

A large number of data drivers are required to simultaneously supply the address pulse to the address electrodes X1-Xm during the address period. For example, a HD (high definition) plasma display apparatus supplying a definition of 1920×1080 comprises 3240 (=1080×3(R,G,B)) address electrodes.

Supposing that one data driver supplies 60 channels and all the channels are used, 54 (=3240÷60) data drivers are required As described above, the large number of data drivers raises the manufacturing cost of the plasma display apparatus.

### SUMMARY OF THE INVENTION

In one aspect a plasma display apparatus comprises a plasma display panel comprising an address electrode, an address electrode driver for generating an address pulse supplied to a plurality of address electrode groups each comprising a plurality of address electrodes through one output terminal, and an electrode group selection unit for supplying the address pulse generated by the address electrode driver to the plurality of address electrode groups.

In another aspect a plasma display apparatus comprises a plasma display panel comprising an address electrode, a data processing unit for dividing video data into video data blocks depending on a plurality of address electrode groups each comprising a plurality of address electrodes, and for outputting the video data blocks, and an address electrode driver for receiving the video data blocks from the data processing unit, and for causing a supply time point of an address pulse supplied to one address electrode belonging to one address electrode group to be different from a supply time point of an address pulse supplied to another address electrode belonging to one address electrode group.

In still another aspect a method of driving a plasma display apparatus comprising a plurality of scan electrodes and a plurality of address electrode groups each comprising a plurality of address electrodes, the method comprises supplying a scan pulse to the plurality of scan electrodes during an address period, and supplying address pulses, which correspond to the scan pulse and have different supply time point depending on the address electrode groups, to the plurality of address electrodes.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates a driving waveform of a related art plasma display apparatus;

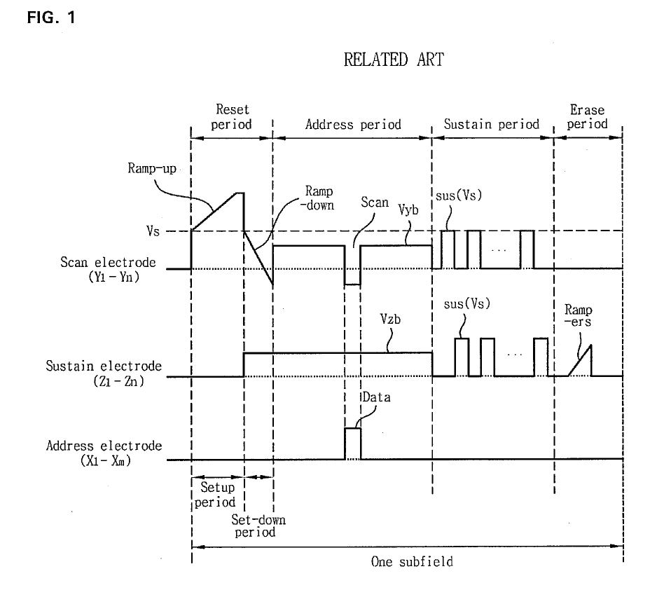

FIG. 2 illustrates the configuration of a related art plasma display apparatus;

FIG. 3 is a block diagram of a plasma display apparatus according to a first embodiment;

FIG. 4 is a block diagram of the configuration of a data processing unit according to the first embodiment;

FIG. 5 illustrates the detailed configuration of the plasma display apparatus according to the first embodiment;

FIG. 6 is a flow chart of a method of driving the plasma display apparatus according to the first embodiment;

FIG. 7 illustrates a driving waveform of the plasma display apparatus according to the first embodiment;

FIG. 8 is a block diagram of a plasma display apparatus according to a second embodiment;

FIG. 9 is a block diagram of the configuration of a data processing unit according to the second embodiment;

FIG. 10 illustrates the detailed configuration of the plasma display apparatus according to the second embodiment;

FIG. 11 is a flow chart of a method of driving the plasma display apparatus according to the second embodiment; and

FIG. 12 illustrates a driving waveform of the plasma display apparatus according to the second embodiment.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel comprising an address electrode, an address electrode driver for generating an address pulse supplied to a plurality of address electrode groups each comprising a plurality of address electrodes through one output terminal, and an electrode group selection unit for supplying the address pulse generated by the address electrode driver to the plurality of address electrode groups.

The plasma display apparatus may further comprise a data processing unit for dividing video data into video data blocks depending on the address electrode groups each comprising the plurality of address electrodes, and for outputting the video data blocks, and a timing controller for receiving the video data blocks from the data processing unit, and for controlling a supply time point of the address pulse corresponding to the video data blocks.

The electrode group selection unit may select a predetermined address electrode group, and may supply the address pulse to the predetermined address electrode group for a duration of subscan, wherein the duration of the subscan is obtained by dividing the width of a scan pulse supplied to one scan electrode by the total number of address electrode groups.

The electrode group selection unit may comprise group selection switches for selecting the predetermined address electrode group of the plurality of address electrode groups. The number of group selection switches may be equal to or more than m/p, where m is the total number of address electrodes, and p is the total number of address electrode groups.

Each of the group selection switches may comprise p switch terminals. Each of the group selection switches may sequentially contact the p switch terminals such that the plurality of address electrode groups are sequentially selected.

The electrode group selection unit may comprise the m/p or more group selection switches, and each of the group selection switches may comprise p switch terminals. A b-th switch terminal of an a-th group selection switch may be connected to an a-th address electrode of a b-th address electrode group, where a is a natural number more than 1 and equal to or less than m/p, and b is a natural number more than 1 and equal to or less than p.

The number of address electrode groups may be equal to two.

The electrode group selection unit may select a predetermined address electrode of a predetermined address electrode group, and may supply the address pulse to the predetermined address electrode of the predetermined address electrode group for a duration of subscan wherein the duration of the subscan is obtained by dividing the width of a scan pulse supplied to one scan electrode by the total number of address electrodes belonging to each of the plurality of address electrode groups.

The electrode group selection unit may comprise a group selection switch for selecting one address electrode of each of the plurality of address electrode groups. The number of group selection switches may be equal to or more than the number of address electrode groups.

Each of the group selection switches may comprise m/p switch terminals. Each of the group selection switches may sequentially contact the m/p switch terminals such that the address electrodes belonging to each of the plurality of address electrode groups are sequentially selected.

The electrode group selection unit may comprise the p or more group selection switches, and each of the p or more group selection switches may comprise the m/p switches. A b-th switch terminal of an a-th group selection switch may be connected to a b-th address electrode of an a-th address electrode group, where a is a natural number more than 1 and equal to or less than p, and b is a natural number more than 1 and equal to or less than m/p.

The number of address electrodes belonging to the plurality of address electrode groups maybe equal to two.

A plasma display apparatus comprises a plasma display panel comprising an address electrode, a data processing unit for dividing video data into video data blocks depending on a plurality of address electrode groups each comprising a plurality of address electrodes, and for outputting the video data blocks, and an address electrode driver for receiving the video data blocks from the data processing unit, and for causing a supply time point of an address pulse supplied to one address electrode belonging to one address electrode group to be different from a supply time point of an address pulse supplied to another address electrode belonging to one address electrode group.

The data processing unit may comprise a data converter for receiving a video signal, and for dividing the video data to be supplied to all the address electrodes into the video data blocks depending on the address electrode groups, a memory for receiving the video data blocks from the data converter, and for storing the video data blocks, and a data output unit for sequentially reading the video data blocks input from the memory when sequentially driving each of the address electrode groups, and for outputting the video data blocks.

The data processing unit may comprise a data converter for receiving the video signal, and for dividing the video data to be supplied to all the address electrodes into two video data blocks depending on two address electrodes of each of the plurality of address electrode groups, a memory for receiving the two video data blocks from the data converter, and for storing the two video data blocks, and a data output unit for sequentially reading the two video data blocks input from the memory when sequentially driving the two address electrodes of each of the plurality of address electrode groups, and for outputting the two video data blocks.

A method of driving a plasma display apparatus comprising a plurality of scan electrodes and a plurality of address electrode groups each comprising a plurality of address electrodes, the method comprises supplying a scan pulse to the plurality of scan electrodes during an address period, and supplying address pulses, which correspond to the scan pulse and have different supply time point depending on the address electrode groups, to the plurality of address electrodes.

The width of the address pulse may be substantially equal to a width obtained by dividing the width of the scan pulse by the number of address electrodes belonging to each of the plurality of address electrode groups.

The number of address electrodes belonging to each of the plurality of address electrode groups may be equal to two.

The width of the address pulse may be substantially equal to a width obtained by dividing the width of the scan pulse by the number of address electrode groups.

The number of address electrode groups may be equal to two.

Hereinafter, exemplary embodiments of the present invention will be described in detail with reference to the attached drawings.

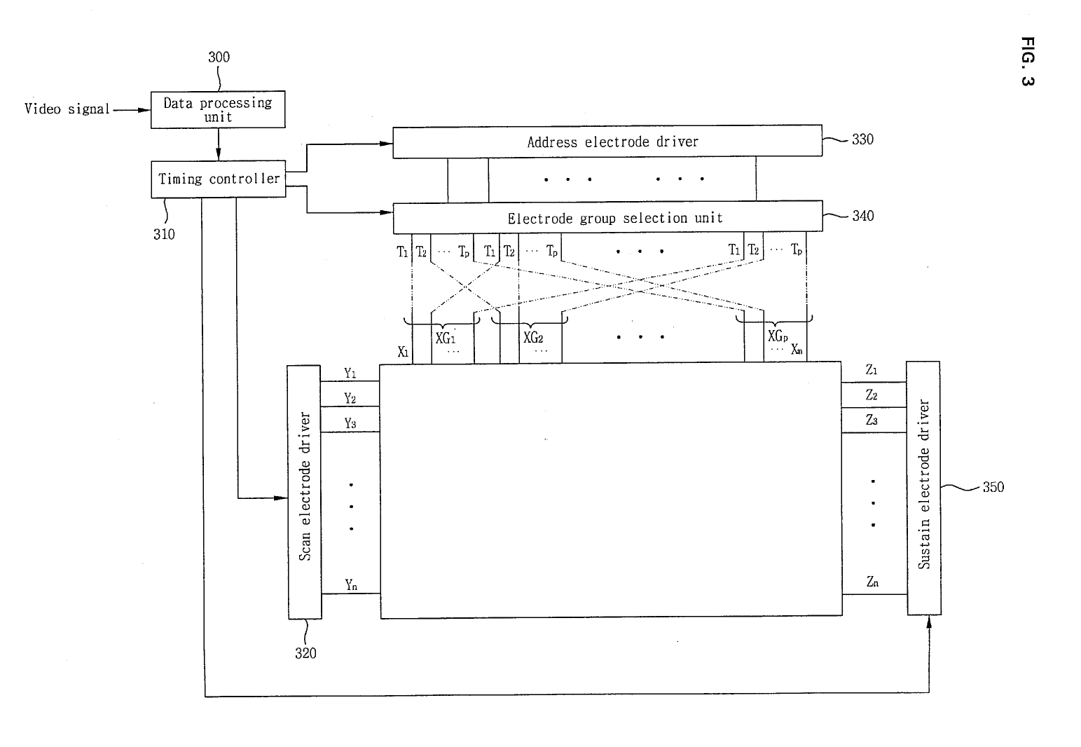

FIG. 3 is a block diagram of a plasma display apparatus according to a first embodiment.

As illustrated in FIG. 3, the plasma display apparatus according to the first embodiment comprises a data processing unit 300, a timing controller 310, a scan electrode driver 320, an address electrode driver 330, an electrode group selection unit 340, and a sustain electrode driver 350.

<Data Processing Unit>

The data processing unit 300 receives a video signal. The data processing unit 300 divides video data to be supplied to all address electrodes X1 to Xm into video data blocks depending on a plurality of address electrode groups each including the plurality of address electrodes, and outputs the corresponding video data blocks for driving each of the plurality of address electrode groups.

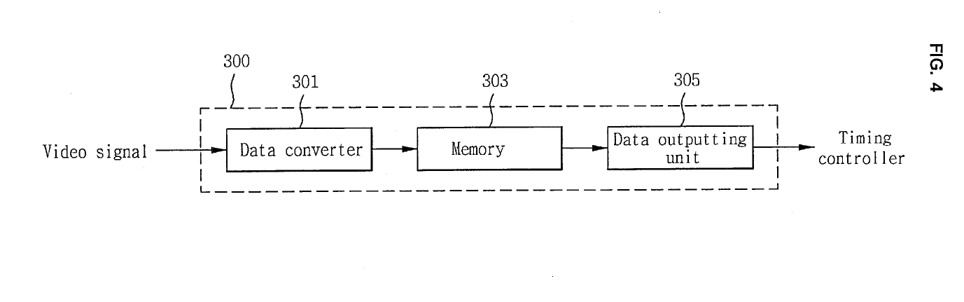

FIG. 4 is a block diagram of the configuration of a data processing unit according to the first embodiment.

As illustrated in FIG. 4, the data processing unit 300 comprises a data converter 301, a memory 303, and a data output unit 305.

The data converter 301 receives the video signal and then divides the video data to be supplied to all the address electrodes X1 to Xm into the video data blocks depending on the number of address electrode groups each including the plurality of address electrodes.

The memory 303 receives the video data blocks from the data converter 301, and stores them.

The data output unit 305 reads the corresponding video data blocks for driving each of the plurality of address electrode groups from the memory 303, and outputs them.

It is preferable that the number of address electrode groups is equal to two. When the number of address electrode groups is equal to two, the data converter 301 receives the video signal, and then divides the video data to be supplied to all the address electrodes X1 to Xm into two video data blocks depending on two address electrode groups.

The memory 303 receives the two video data blocks from the data converter 301, and stores the two video data blocks.

The data output unit 305 sequentially reads the two video data blocks input from the memory 303 when sequentially driving each of the two address electrode groups, and outputs the two video data blocks.

<Timing Controller>

The timing controller 310 controls a supply time point of an address pulse depending on the video data block input from the data processing unit 300, and controls a supply time point of a driving pulse for driving scan electrodes Y1 to Yn and sustain electrodes Z1 to Zn.

<Scan Electrode Driver>

The scan electrode driver 320, under the control of the timing controller 310, supplies a reset pulse, a scan pulse, and a sustain pulse to each of the scan electrodes Y1 to Yn. The reset pulse causes wall charges within each cell to be uniform, the scan pulse selects the cell to generate a sustain discharge, and the sustain pulse maintains the sustain discharge of the selected cell.

<Address Electrode Driver>

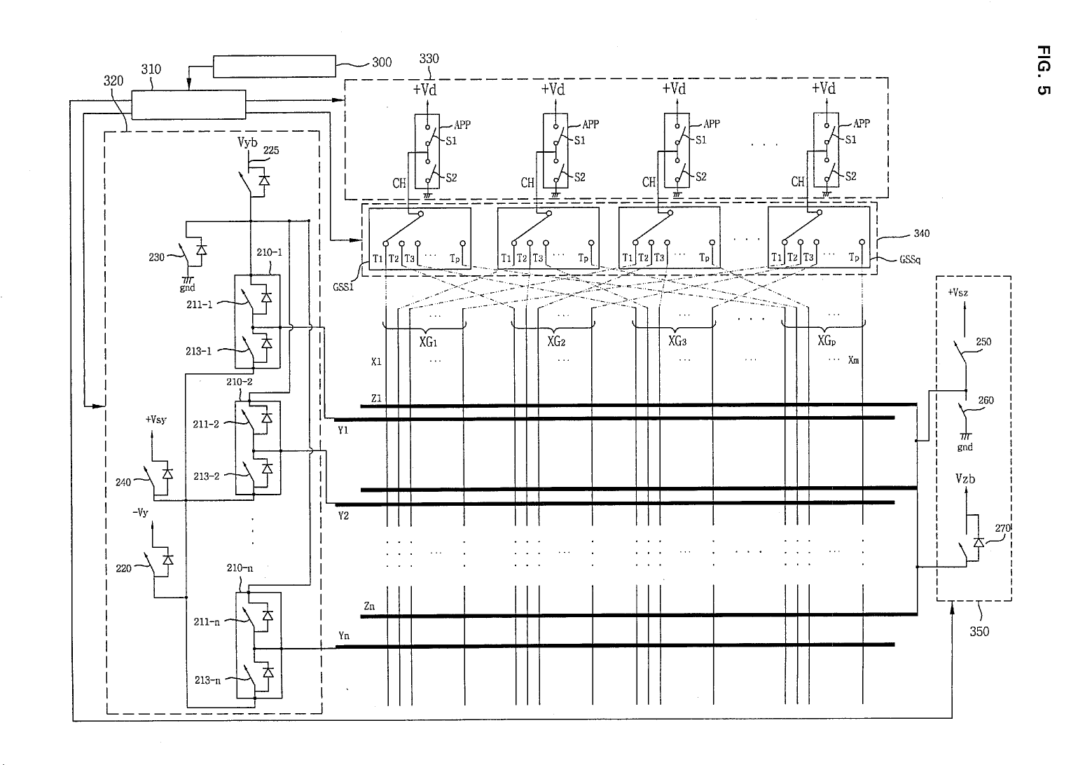

The address electrode driver 330 comprises one or more data drivers (not illustrated). The address electrode driver 330 forms an address pulse supplied to the address electrodes of each of the plurality of address electrode groups driven under the control of the timing controller 310. The data driver comprises a plurality of address pulse supply unit APP (refer to FIG. 5). One address pulse supply unit APP is assigned to one channel CH (refer to FIG. 5).

<Electrode Group Selection Unit>

The electrode group selection unit 340, under the control of the timing controller 310, selects a predetermined address electrode group, and then supplies an address pulse formed by the data driver (not illustrated) to the address electrodes of the predetermined address electrode group.

The electrode group selection unit 340 selects the predetermined address electrode group, and then supplies the address pulse to the address electrodes of the predetermined address electrode group for a duration of subscan. The duration of the subscan is obtained by dividing the width of the scan pulse supplied to one scan electrode by the total number of address electrode groups.

<Sustain Electrode Driver>

The sustain electrode driver 350, under the control of the timing controller 310, supplies a sustain pulse to the sustain electrodes Z1 to Zn. The sustain electrode driver 350 and the scan electrode driver 320 alternately operate.

In the plasma display apparatus according to the first embodiment, the data driver of the address electrode driver 330 supplies the address pulse to p address electrode groups XG1 to XGp, thereby minimizing the number of data drivers.

It is preferable that the data driver of the address electrode driver 330 sequentially supplies the address pulse to two address electrode groups.

All the address electrode groups may comprise an equal number of address electrodes. Further, the number of address electrodes of at least one of all the address electrode groups maybe different from the number of address electrodes of the remaining address electrode groups.

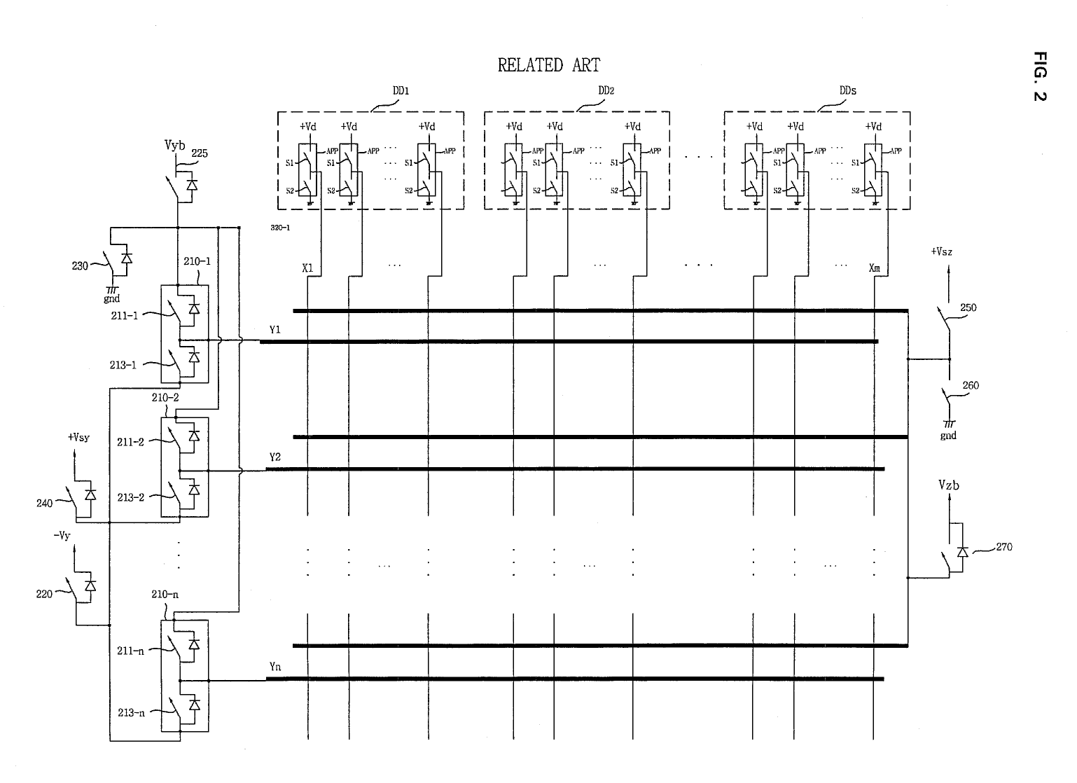

FIG. 5 illustrates the detailed configuration of the plasma display apparatus according to the first embodiment. Since the configurations of the scan electrode driver 320 and the sustain electrode driver 350 of the plasma display apparatus according to the first embodiment is the same as the configurations of the scan electrode driver and the sustain electrode driver of the plasma display apparatus illustrated in FIG. 2, a description thereof is omitted

As illustrated in FIG. 5, the electrode group selection unit 340 comprises q group selection switches GSS1 to GSSq for selecting one address electrode group of the p address electrode groups XG1 to XGp.

The q group selection switches GSS1 to GSSq each comprise p switch terminals T1 to Tp to supply the address pulse formed by the address pulse supply units APP of the data driver to each of the p address electrode groups XG1 to XGp.

Each of the q group selection switches GSS1 to GSSq sequentially contacts the p switch terminals T1 to Tp, thereby sequentially selecting the p address electrode groups XG1 to XGp.

More specifically, when each of the group selection switches GSS1 to GSSq contacts the first switch terminal T1, the address pulse formed by each of the address pulse supply units APP is supplied to the address electrodes of the first address electrode group XG1.

Next, when each of the group selection switches GSS1 to GSSq contacts the second switch terminal T2, the address pulse formed by each of the address pulse supply units APP is supplied to the address electrodes of the second address electrode group XG2.

The above-described processes are repeatedly performed. Finally, when each of the group selection switches GSS1 to GSSq contacts the p-th switch terminal Tp, the address pulse formed by each of the address pulse supply units APP is supplied to the address electrodes of the p-th address electrode group XGp.

Where q is a natural number equal to or more than a value obtained by dividing the total number (m) of address electrodes by the total number (p) of address electrode groups.

For example, when dividing 100 (=m) address electrodes by 4 (=p) address electrode groups, one address electrode group comprises 25 (=100/4=m/p=q) address electrodes.

Accordingly, 25 (=q=m/p) or more group selection switches are required to supply the address pulse to each of the 25 address electrodes.

In other words, a b-th switch terminal of an a-th group selection switch is connected to an a-th address electrode of a b-th address electrode group, where a is a natural number more than 1 and equal to or less than m/p, and b is a natural number more than 1 and equal to or less than p.

For example, the second (=b) switch terminal of the first (=a) group selection switch is connected to the first (=a) address electrode of the second (=b) address electrode group.

When scanning one scan electrode, the electrode group selection unit 340 sequentially selects each of the p address electrode groups XG1 to XGp, and then supplies the address pulse to the predetermined address electrode group of the p address electrode groups XG1 to XGp.

In other words, the timing controller 310 controls the electrode group selection unit 340 to supply the address pulse to one address electrode group for a duration of time (w/p) obtained by dividing the width (w) of the scan pulse supplied to one scan electrode by the total number of address electrode groups.

The following is a detailed description of a method of driving the plasma display apparatus according to the first embodiment.

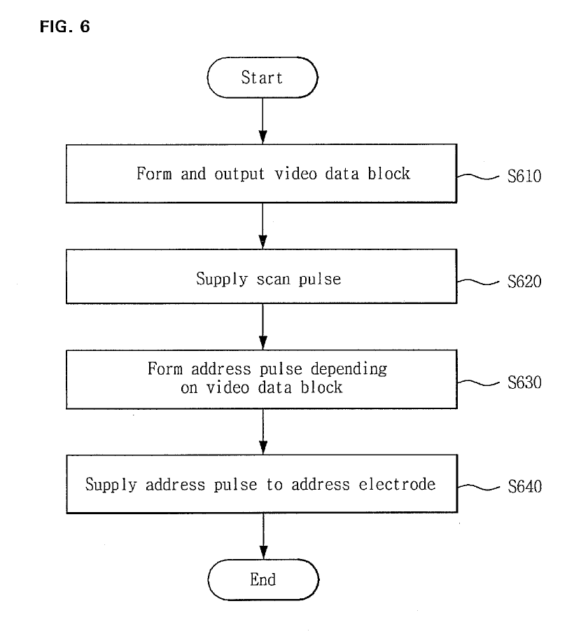

FIG. 6 is a flow chart of a method of driving the plasma display apparatus according to the first embodiment.

As illustrated in FIG. 6, the method of driving the plasma display apparatus according to the first embodiment mainly comprises four steps.

In a first step S610, the video signal is input, and the video data to be supplied to all the address electrodes is then divided into the video data blocks depending on the number of address electrode groups. Next, the video data blocks corresponding to the address electrode groups are output.

In a second step S620, the scan pulse is supplied to the scan electrode.

In a third step S630, the address pulse is formed depending on the video data blocks corresponding to the address electrode groups during the supplying of the scan pulse to the scan electrode.

In a fourth step S640, the formed address pulse is supplied to the address electrode groups corresponding to the video data blocks.

In other words, a duration of time required to supply one scan pulse to one scan electrode is divided into durations of subscan equal to the number of address electrode groups.

The address pulse is sequentially supplied to each of the address electrode groups. For example, when all the address electrodes are divided into two address electrode groups, a duration of time required to supply one scan pulse to one scan electrode is divided into two durations of subscan.

During a first duration of subscan the corresponding address pulse is supplied to the first address electrode group. Next, during a second duration of subscan the corresponding address pulse is supplied to the second address electrode group.

The outputting of the video data blocks (the first step S610) comprises dividing the video data into the video data blocks depending on the number of address electrode groups each including the plurality of address electrodes, receiving the video data blocks to store the received video data blocks, and reading the stored video data blocks corresponding to the address electrode groups to output the read video data blocks.

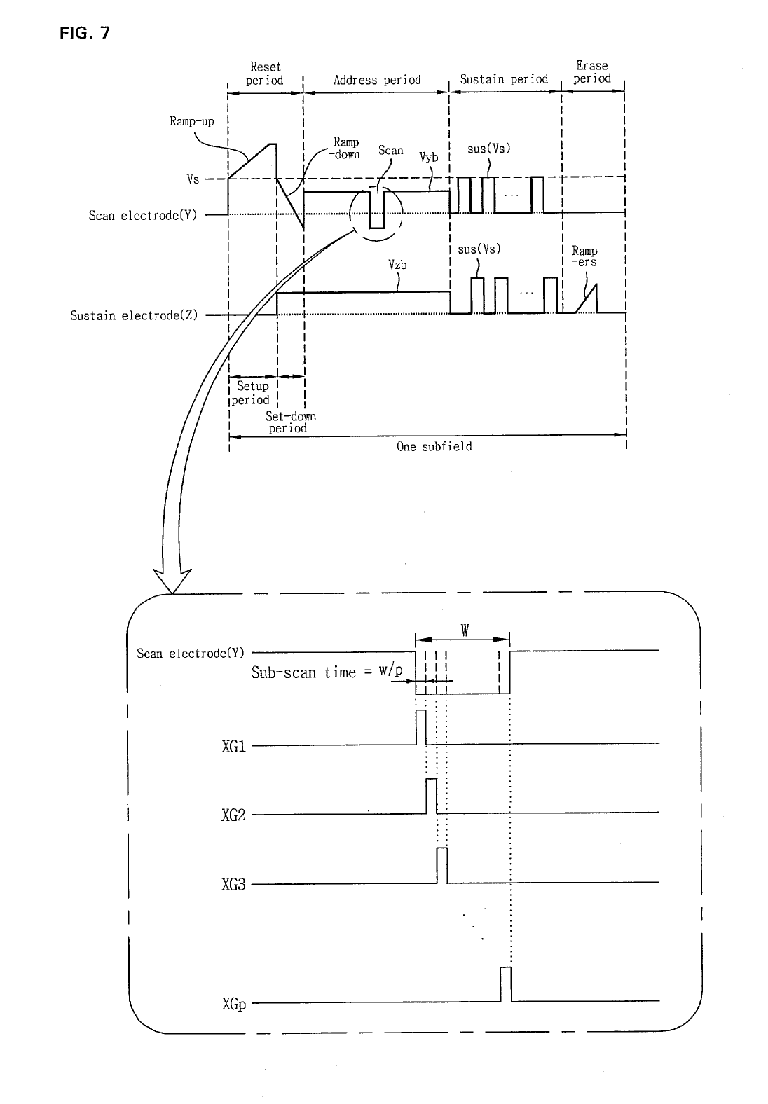

The method of driving the plasma display apparatus according to the first embodiment will be described below in more detail, with reference to FIGS. 5 and 7.

FIG. 7 illustrates a driving waveform of the plasma display apparatus according to the first embodiment.

The data processing unit 300 receives the video signal. The data processing unit 300 divides the video data to be supplied to all the address electrodes X1 to Xm into the video data blocks depending on the address electrode groups, then stores the received video data blocks.

When an address period, which follows a reset period, starts, under the control of the timing controller 320, a second switch 213-1 of a first scan driver 210-1 and a first scanning switch 220 are turned on, thereby supplying the scan pulse of a negative voltage −Vy having a constant pulse width (w) to the first scan electrode Y1.

The timing controller 310 receives the corresponding video data block from the data processing unit 300. Then, the timing controller 3 10 causes each of the group selection switches GSS1 to GSSq of the electrode group selection unit 340 to contact the first to p-th switch terminals T1 to Tp of each of the group selection switches GSS1 to GSSq in order for each of durations of subscan (w/p) obtained by dividing the width (w) of the scan pulse supplied to each scan electrode by the number (p) of address electrode groups, thereby supplying the address pulse depending on the corresponding video data block to the address electrode groups XG1 to XGp.

In other words, the group selection switches GSS1 to GSSq, under the control of the timing controller 310, contact the first switch terminal T1 for a first duration of subscan

Accordingly, all the address pulse supply units APP supply an address pulse generated under the control of the timing controller 310 to the first address electrode group XG1.

When the first data switch S1 is turned on, the address pulse supply unit APP generates an address pulse having a data voltage +Vd. When the second data switch S2 is turned on, the address pulse supply unit APP generates an address pulse having a ground level voltage.

Next, the group selection switches GSS1 to GSSq, under the control of the timing controller 310, contact the second switch terminal T2 for a second duration of subscan

Accordingly, all the address pulse supply units APP supply an address pulse generated under the control of the timing controller 310 to the second address electrode group XG2.

The above-described process is performed repeatedly. Finally, the group selection switches GSS1 to GSSq, under the control of the timing controller 310, contact the p-th switch terminal Tp for a p-th duration of subscan.

Accordingly, all the address pulse supply units APP supply an address pulse generated under the control of the timing controller 310 to the p-th address electrode group XGp, thereby completing the addressing of all the cells existing on the first scan electrode Y1.

The above-described processes are performed for supplying the scan pulse to the remaining scan electrodes Y2 to Yn.

Since the plasma display apparatus according to the first embodiment sequentially supplies the corresponding address pulse to the p address electrode groups XG1 to XGp through the channels of the address electrode driver 330, the address pulse is supplied to all the address electrodes X1 to Xm using a small number of channels.

In other words, while one channel is assigned to one address electrode in the plasma display apparatus illustrated in FIG. 2, one channel is assigned to the p address electrodes in the plasma display apparatus according to the first embodiment. Accordingly, the plasma display apparatus according to the first embodiment supplies the address pulse to all the address electrodes X1 to Xm using the number of channels less than the number of channels of the plasma display apparatus illustrated in FIG. 2.

This results in a reduction in the number of data drivers for supporting a predetermined number of channels, thereby reducing the manufacturing cost of the plasma display apparatus.

When the addressing of all the cells is completed through the operation of the plasma display apparatus according to the first embodiment, a first sustain switch 240, the second switches 213-1 to 213-n of the scan drivers 210-1 to 210-n, and a second ground switch 260 are turned on.

As a result, a loop passing through the first sustain switch 240, the second switches 213-1 to 213-n of the scan drivers 210-1 to 210-n, the scan electrodes Y1 to Yn, the sustain electrodes Z1 to Zn, and the second ground switch 260 is formed such that a first sustain voltage (+Vsy) is supplied to the scan electrodes Y1 to Yn.

Next, a second sustain switch 250, the first switches 211-1 to 211-n of the scan drivers 210-1 to 210-n, and a first ground switch 230 are turned on.

As a result, a loop passing through the sustain electrodes Z1 to Zn, the scan electrodes Y1 to Yn, the first switches 211-1 to 211-n of the scan drivers 210-1 to 210-n, and the first ground switch 230 is formed such that a second sustain voltage (+Vsz) is supplied to the sustain electrodes Z1 to Zn.

The first sustain voltage (+Vsy) and the second sustain voltage (+Vsz) are alternately supplied to the scan electrodes Y1 to Yn and the sustain electrodes Z1 to Zn, thereby generating the sustain discharge in the cell selected during the address period.

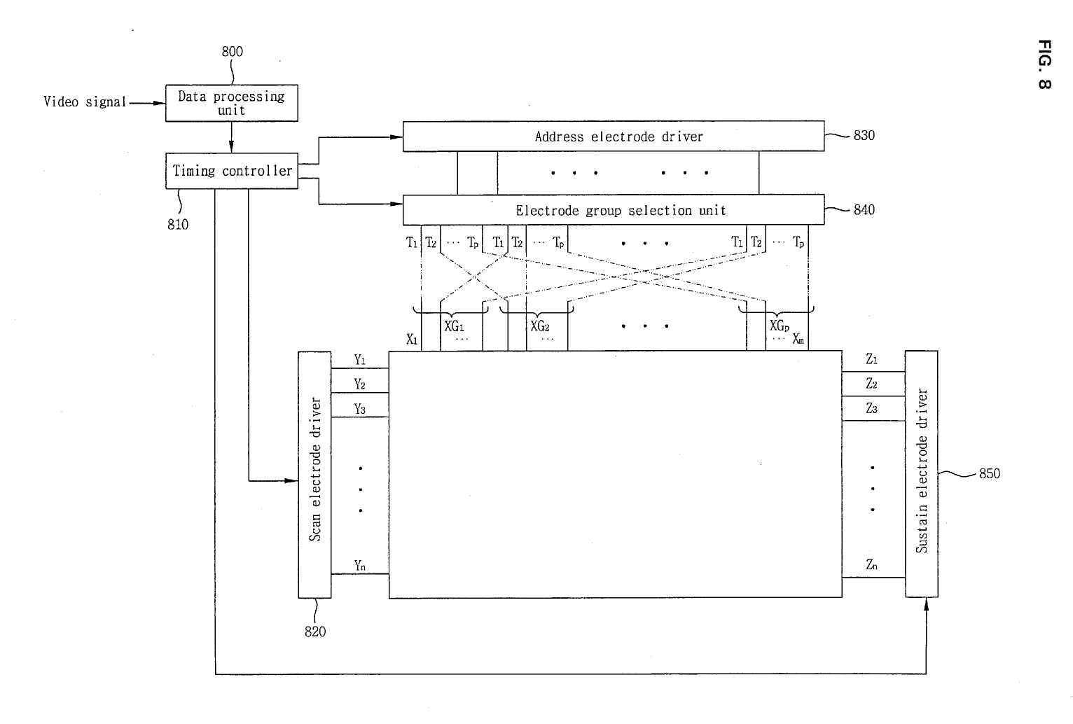

FIG. 8 is a block diagram of a plasma display apparatus according to a second embodiment.

As illustrated in FIG. 8, the plasma display apparatus according to the second embodiment comprises a data processing unit 800, a timing controller 810, a scan electrode driver 820, an address electrode driver 830, an electrode group selection unit 840, and a sustain electrode driver 850.

<Data Processing Unit>

The data processing unit 800 receives a video signal. The data processing unit 800 divides video data to be supplied to all address electrodes X1 to Xm into video data blocks depending on a plurality of address electrodes belonging to each of a plurality of address electrode groups, and outputs the corresponding video data blocks for driving each of the address electrode groups.

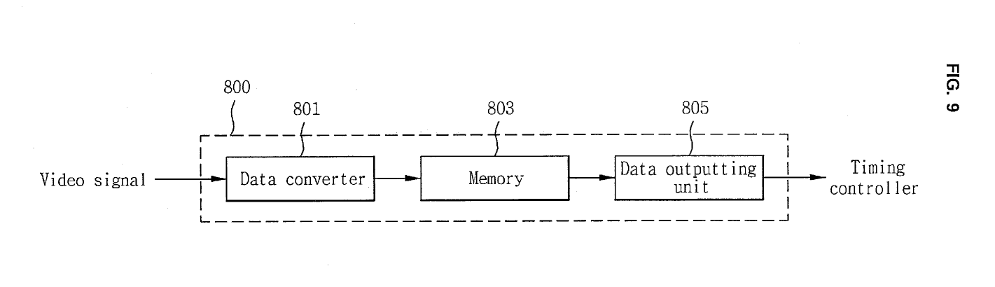

FIG. 9 is a block diagram of the configuration of a data processing unit according to the second embodiment.

As illustrated in FIG. 9, the data processing unit 800 comprises a data converter 801, a memory 803, and a data output unit 805.

The data converter 801 receives the video signal and then divides the video data to be supplied to all the address electrodes X1 to Xm into the video data blocks depending on the number of address electrodes belonging to each of the plurality of address electrode groups.

The memory 803 receives the video data blocks from the data converter 801, and stores them.

The data output unit 805 reads the corresponding video data blocks for driving each of the address electrode groups from the memory 803, and outputs them.

It is preferable that the number of address electrodes belonging to each of the plurality of address electrode groups is equal to two. When the number of address electrodes belonging to each of the plurality of address electrode groups is equal to two, the data converter 801 receives the video signal, and then divides the video data to be supplied to all the address electrodes X1 to Xm into two video data blocks depending on two address electrodes belonging to each of the plurality of address electrode groups.

The memory 803 receives the two video data blocks from the data converter 801, and stores the two video data blocks.

The data output unit 805 sequentially reads the two video data blocks input from the memory 803 when sequentially driving two address electrodes belonging to each of the plurality of address electrode groups, and outputs the two video data blocks.

<Timing Controller>

The timing controller 810 controls a supply time point of an address pulse depending on the video data block input from the data processing unit 800, and controls a supply time point of a driving pulse for driving scan electrodes Y1 to Yn and sustain electrodes Z1 to Zn.

<Scan Electrode Driver>

The scan electrode driver 820, under the control of the timing controller 810, supplies a reset pulse, a scan pulse, and a sustain pulse to each of scan electrodes Y1 to Yn. The reset pulse causes wall charges within each cell to be uniform, the scan pulse selects the cell to generate a sustain discharge, and the sustain pulse maintains the sustain discharge of the selected cell.

<Address Electrode Driver>

The address electrode driver 830 comprises one or more data drivers (not illustrated). The address electrode driver 830 forms an address pulse supplied to the address electrodes belonging to the plurality of address electrode groups driven under the control of the timing controller 810.

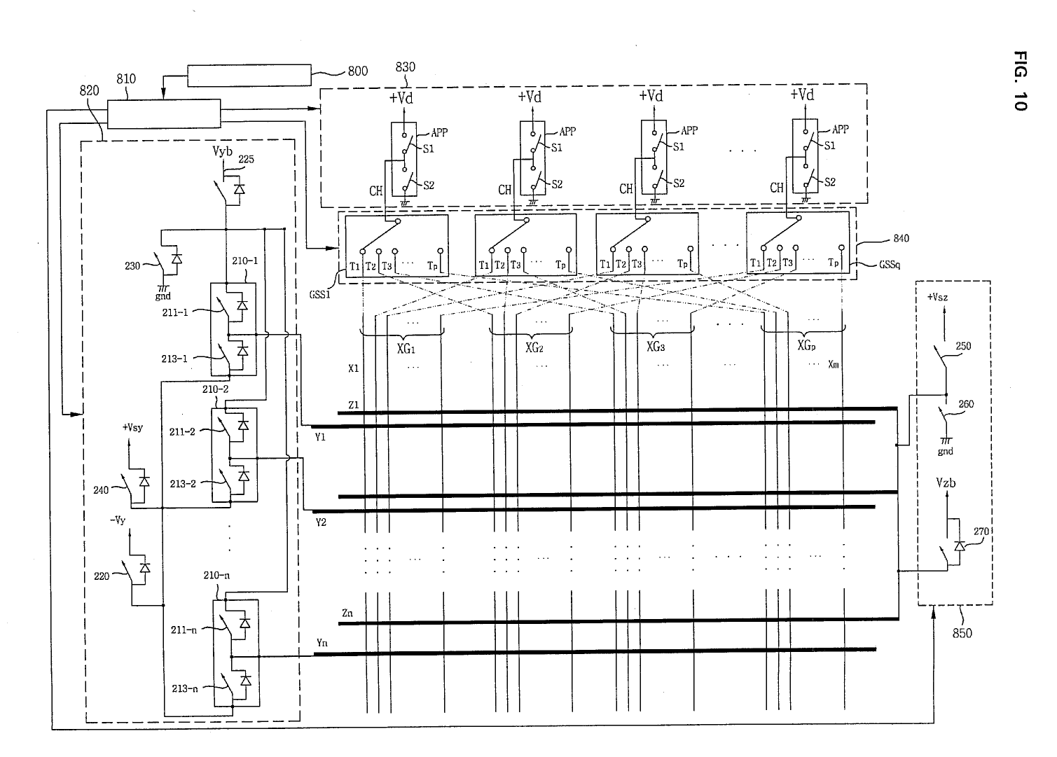

The data driver comprises a plurality of address pulse supply unit APP (refer to FIG. 10). One address pulse supply unit APP is assigned to one channel CH (refer to FIG. 10).

<Electrode Group Selection Unit>

The electrode group selection unit 840, under the control of the timing controller 810, selects a predetermined address electrode belonging to a predetermined address electrode group, and then supplies an address pulse formed by the data driver (not illustrated) to the predetermined address electrode belonging to the predetermined address electrode group.

The electrode group selection unit 840 selects the predetermined address electrode, and then supplies the address pulse to the predetermined address electrodes o f the predetermined address electrode group for a duration of subscan The duration of the subscan is obtained by dividing the width of the scan pulse supplied to one scan electrode by the total number of address electrodes belonging to one address electrode group.

<Sustain Electrode Driver>

The sustain electrode driver 850, under the control of the timing controller 810, supplies a sustain pulse to the sustain electrodes Z1 to Zn. The sustain electrode driver 850 and the scan electrode driver 820 alternately operate.

In the plasma display apparatus according to the second embodiment, the data driver of the address electrode driver 830 supplies the address pulse to p address electrode groups XG1 to XGp, thereby minimizing the number of data drivers.

It is preferable that the data driver of the address electrode driver 830 sequentially supplies the address pulse to the plurality of address electrode groups each comprising the two address electrodes.

FIG. 10 illustrates the detailed configuration of the plasma display apparatus according to the second embodiment. Since the configurations of the scan electrode driver 820 and the sustain electrode driver 850 of the plasma display apparatus according to the second embodiment is the same as the configurations of the scan electrode driver and the sustain electrode driver of the plasma display apparatus illustrated in FIG. 2, a description thereof is omitted.

As illustrated in FIG. 10, the electrode group selection unit 840 comprises p group selection switches GSS1 to GSSp for selecting one of the address electrodes belonging to each of the p address electrode groups XG1 to XGp.

The p group selection switches GSS1 to GSSp each comprise q switch terminals T1 to Tq to supply the address pulse formed by the address pulse supply units APP of the data driver to each of the p address electrode groups XG1 to XGp.

Each of the p group selection switches GSS1 to GSSp sequentially contacts the q switch terminals T1 to Tq, thereby sequentially selecting the plurality of address electrodes belonging to each of the p address electrode groups XG1 to XGp.

More specifically, when each of the group selection switches GSS1 to GSSp contacts the first switch terminal T1, the address pulse formed by each of the address pulse supply units APP is supplied to a first address electrode of the plurality of address electrodes belonging to each of the p address electrode groups XG1 to XGp.

Next, when each of the group selection switches GSS1 to GSSp contacts the second switch terminal T2, the address pulse formed by each of the address pulse supply units APP is supplied to a second address electrode of the plurality of address electrodes belonging to each of the p address electrode groups XG1 to XGp.

The above-described processes are repeatedly performed. Finally, when each of the group selection switches GSS1 to GSSp contacts the q-th switch terminal Tq, the address pulse formed by each of the address pulse supply units APP is supplied to a q-th address electrode of the plurality of address electrodes belonging to each of the p address electrode groups XG1 to XGp.

Where q is a natural number equal to or more than a value obtained by dividing the total number (m) of address electrodes by the total number (p) of address electrode groups.

For example, when dividing 100 (=m) address electrodes by 50 (=p) address electrode groups, one address electrode group comprises 2 (=100/50=m/p=q) address electrodes.

Accordingly, 50 (=q=m/p) or more group selection switches are required to supply the address pulse to each of the two address electrodes.

In other words, a b-th switch terminal of an a-th group selection switch is connected to a b-th address electrode of an a-th address electrode group, where a is a natural number more than 1 and equal to or less than p, and b is a natural number more than 1 and equal to or less than m/p.

For example, the second (=b) switch terminal of the first (=a) group selection switch is connected to the second (=b) address electrode of the first (=a) address electrode group.

When scanning one scan electrode, the electrode group selection unit 840 sequentially selects the address electrodes belonging to each of the address electrode groups XG1 to XGp, and then supplies the address pulse to the predetermined address electrode of each of the address electrode groups XG1 to XGp.

In other words, the timing controller 810 controls the electrode group selection unit 840 to supply the address pulse to one address electrode of each of the address electrode groups XG1 to XGp for a duration of time (w/q) obtained by dividing the width (w) of the scan pulse supplied to one scan electrode by the total number of address electrodes belonging to one address electrode group.

The following is a detailed description of a method of driving the plasma display apparatus according to the second embodiment.

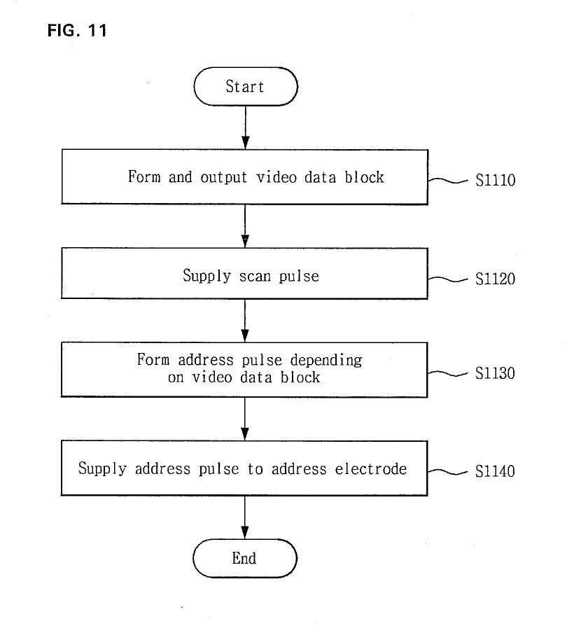

FIG. 11 is a flow chart of a method of driving the plasma display apparatus according to the second embodiment.

As illustrated in FIG. 11, the method of driving the plasma display apparatus according to the second embodiment mainly comprises four steps.

In a first step S1110, the video signal is input, and the video data to be supplied to all the address electrodes is then divided into the video data blocks depending on the number of address electrodes belonging to each of the plurality of address electrode groups. Next, the video data blocks are output.

In a second step S1120, the scan pulse is supplied to the scan electrode.

In a third step S1130, the address pulse is formed depending on the video data blocks during the supplying of the scan pulse to the scan electrode.

In a fourth step S1140, the formed address pulse is supplied to the address electrodes belonging to each of the plurality of address electrode groups corresponding to the video data blocks.

In other words, a duration of time required to supply one scan pulse to one scan electrode is divided into durations of subscan equal to the number of address electrodes belonging to each of the plurality of address electrode groups.

The address pulse is sequentially supplied to the address electrodes belonging to each of the plurality of address electrode groups. For example, when each of the plurality of address electrode groups comprises two address electrodes, a duration of time required to supply one scan pulse to one scan electrode is divided into two durations of subscan.

During a first duration of subscan the corresponding address pulse is supplied to the first address electrode of each of the plurality of address electrode groups. Next, during a second duration of subscan, the corresponding address pulse is supplied to the second address electrode of each of the plurality of address electrode groups.

The outputting of the video data blocks (the first step S1110) comprises dividing the video data into the video data blocks depending on the number of address electrodes belonging to each of the plurality of address electrode groups, receiving the video data blocks to store the received video data blocks, and reading the stored video data blocks to output the read video data blocks.

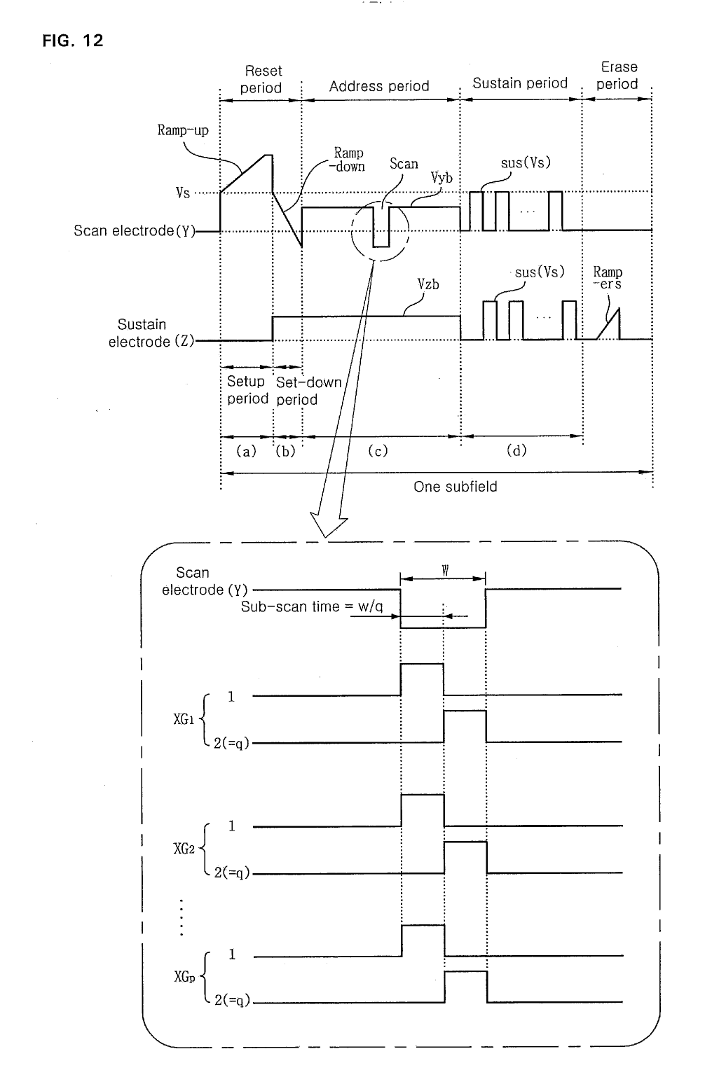

The method of driving the plasma display apparatus according to the second embodiment will be described below in more detail, with reference to FIGS. 10 and 12.

FIG. 12 illustrates a driving waveform of the plasma display apparatus according to the second embodiment.

The data processing unit 800 receives the video signal. The data processing unit 800 divides the video data to be supplied to all the address electrodes X1 to Xm into the video data blocks depending on the number of address electrodes belonging to each of the plurality of address electrode groups, then stores the received video data blocks.

When an address period, which follows a reset period, starts, under the control of the timing controller 820, a second switch 213-1 of a first scan driver 210-1 and a first scanning switch 220 are turned on, thereby supplying the scan pulse of a negative voltage −Vy having a constant pulse width (w) to the first scan electrode Y1.

The timing controller 810 receives the corresponding video data block from the data processing unit 800. Then, the timing controller 810 causes each of the group selection switches GSS1 to GSSp of the electrode group selection unit 840 to contact the first to q-th switch terminals T1 to Tq of each of the group selection switches GSS1 to GSSp in order for each of durations of subscan (w/q) obtained by dividing the width (w) of the scan pulse supplied to each scan electrode by the number (q) of address electrodes belonging to each of the address electrode groups XG1 to XGp, thereby supplying the address pulse depending on the corresponding video data block to each of the address electrode groups XG1 to XGp.

In other words, the group selection switches GSS1 to GSSp, under the control of the timing controller 810, contact the first switch terminal T1 for a first duration of subscan

Accordingly, all the address pulse supply units APP supply an address pulse generated under the control of the timing controller 810 to the first address electrode of each of the plurality of address electrode groups XG1 to XGp.

When the first data switch S1 is tuned on, the address pulse supply unit APP generates an address pulse having a data voltage +Vd. When the second data switch S2 is turned on, the address pulse supply unit APP generates an address pulse having a ground level voltage.

Next, the group selection switches GSS1 to GSSp, under the control of the timing controller 810, contact the second switch terminal T2 for a second duration of subscan

Accordingly, all the address pulse supply units APP supply an address pulse generated under the control of the timing controller 810 to the second address electrode of each of the plurality of address electrode groups XG1 to XGp.

The above-described process is performed repeatedly. Finally, the group selection switches GSS1 to GSSp, under the control of the timing controller 810, contact the q-th switch terminal Tq for a q-th duration of subscan.

Accordingly, all the address pulse supply units APP supply an address pulse generated under the control of the timing controller 810 to the q-th address electrode of each of the plurality of address electrode groups XG1 to XGp, thereby completing the addressing of all the cells existing on the first scan electrode Y1.

The above-described processes are performed for supplying the scan pulse to the remaining scan electrodes Y2 to Yn.

Since the plasma display apparatus according to the second embodiment sequentially supplies the corresponding address pulse to the p address electrode groups XG1 to XGp through the channels of the address electrode driver 830, the address pulse is supplied to all the address electrodes X1 to Xm using a small number of channels.

In other words, while one channel is assigned to one address electrode in the plasma display apparatus illustrated in FIG. 2, one channel is assigned to the q address electrodes in the plasma display apparatus according to the second embodiment. Accordingly, the plasma display apparatus according to the second embodiment supplies the address pulse to all the address electrodes X1 to Xm using the number of channels less than the number of channels of the plasma display apparatus illustrated in FIG. 2.

This results in a reduction in the number of data drivers for supporting a predetermined number of channels, thereby reducing the manufacturing cost of the plasma display apparatus.

When the addressing of all the cells is completed through the operation of the plasma display apparatus according to the second embodiment, a first sustain switch 240, the second switches 213-1 to 213-n of the scan drivers 210-1 to 210-n, and a second ground switch 260 are turned on.

As a result, a loop passing through the first sustain switch 240, the second switches 213-1 to 213-n of the scan drivers 210-1 to 210-n, the scan electrodes Y1 to Yn, the sustain electrodes Z1 to Zn, and the second ground switch 260 is formed such that a first sustain voltage (+Vsy) is supplied to the scan electrodes Y1 to Yn.

Next, a second sustain switch 250, the first switches 211-1 to 211-n of the scan drivers 210-1 to 210-n, and a first ground switch 230 are turned on.

As a result, a loop passing through the sustain electrodes Z1 to Zn, the scan electrodes Y1 to Yn, the first switches 211-1 to 211-n of the scan drivers 210-1 to 210-n, and the first ground switch 230 is formed such that a second sustain voltage (+Vsz) is supplied to the sustain electrodes Z1 to Zn.

The first sustain voltage (+Vsy) and the second sustain voltage (+Vsz) are alternately supplied to the scan electrodes Y1 to Yn and the sustain electrodes Z1 to Zn, thereby generating the sustain discharge in the cell selected during the address period.

As described above, one channel of the data driver is assigned to a large number of address electrodes by dividing the address period, thereby reducing the number of data drivers. Further, the manufacturing of the plasma display apparatus decreases.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising an address electrode;
an address electrode driver for generating an address pulse supplied to a plurality of address electrode groups each comprising a plurality of address electrodes through one output terminal; and
an electrode group selection unit for supplying the address pulse generated by the address electrode driver to the plurality of address electrode groups.

2. The plasma display apparatus of claim 1, further comprising a data processing unit for dividing video data into video data blocks depending on the address electrode groups each comprising the plurality of address electrodes, and for outputting the video data blocks, and
a timing controller for receiving the video data blocks from the data processing unit, and for controlling a supply time point of the address pulse corresponding to the video data blocks.

3. The plasma display apparatus of claim 2, wherein the electrode group selection unit selects a predetermined address electrode group, and supplies the address pulse to the predetermined address electrode group for a duration of subscan,
wherein the duration of the subscan is obtained by dividing the width of a scan pulse supplied to one scan electrode by the total number of address electrode groups.

4. The plasma display apparatus of claim 3, wherein the electrode group selection unit comprises group selection switches for selecting the predetermined address electrode group of the plurality of address electrode groups, and
wherein the number of group selection switches is equal to or more than m/p, where m is the total number of address electrodes, and p is the total number of address electrode groups.

5. The plasma display apparatus of claim 4, wherein each of the group selection switches comprises p switch terminals,
each of the group selection switches sequentially contacts the p switch terminals such that the plurality of address electrode groups are sequentially selected.

6. The plasma display apparatus of claim 4, wherein the electrode group selection unit comprises the m/p or more group selection switches, and each of the group selection switches comprises p switch terminals,
wherein a b-th switch terminal of an a-th group selection switch is connected to an a-th address electrode of a b-th address electrode group, where a is a natural number more than 1 and equal to or less than m/p, and b is a natural number more than 1 and equal to or less than p.

7. The plasma display apparatus of claim 3, wherein the number of address electrode groups is equal to two.

8. The plasma display apparatus of claim 2, wherein the electrode group selection unit selects a predetermined address electrode of a predetermined address electrode group, and supplies the address pulse to the predetermined address electrode of the predetermined address electrode group for a duration of subscan,
wherein the duration of the subscan is obtained by dividing the width of a scan pulse supplied to one scan electrode by the total number of address electrodes belonging to each of the plurality of address electrode groups.

9. The plasma display apparatus of claim 8, wherein the electrode group selection unit comprises a group selection switch for selecting one address electrode of each of the plurality of address electrode groups,
wherein the number of group selection switches is equal to or more than the number of address electrode groups.

10. The plasma display apparatus of claim 9, wherein each of the group selection switches comprises m/p switch terminals,
wherein each of the group selection switches sequentially contacts the m/p switch terminals such that the address electrodes belonging to each of the plurality of address electrode groups are sequentially selected.

11. The plasma display apparatus of claim 9, wherein the electrode group selection unit comprises the p or more group selection switches, and each of the p or more group selection switches comprises the m/p switches,
wherein a b-th switch terminal of an a-th group selection switch is connected to a b-th address electrode of an a-th address electrode group, where a is a natural number more than 1 and equal to or less than p, and b is a natural number more than 1 and equal to or less than m/p.

12. The plasma display apparatus of claim 8, wherein the number of address electrodes belonging to each of the plurality of address electrode groups is equal to two.

13. A plasma display apparatus comprising:
a plasma display panel comprising an address electrode;
a data processing unit for dividing video data into video data blocks depending on a plurality of address electrode groups each comprising a plurality of address electrodes, and for outputting the video data blocks; and
an address electrode driver for receiving the video data blocks from the data processing unit, and for causing a supply time point of an address pulse supplied to one address electrode belonging to one address electrode group to be different from a supply time point of an address pulse supplied to another address electrode belonging to one address electrode group.

14. The plasma display apparatus of claim 13, wherein the data processing unit comprises a data converter for receiving a video signal, and for dividing the video data to be supplied to all the address electrodes into the video data blocks depending on the address electrode groups,
a memory for receiving the video data blocks from the data converter, and for storing the video data blocks, and
a data output unit for sequentially reading the video data blocks input from the memory when sequentially driving each of the address electrode groups, and for outputting the video data blocks.

15. The plasma display apparatus of claim 14, wherein the data processing unit comprises
a data converter for receiving the video signal, and for dividing the video data to be supplied to all the address electrodes into two video data blocks depending on two address electrodes of each of the plurality of address electrode groups,
a memory for receiving the two video data blocks from the data converter, and for storing the two video data blocks, and
a data output unit for sequentially reading the two video data blocks input from the memory when sequentially driving the two address electrodes of each of the plurality of address electrode groups, and for outputting the two video data blocks.

16. A method of driving a plasma display apparatus comprising a plurality of scan electrodes and a plurality of address electrode groups each comprising a plurality of address electrodes, the method comprising:
supplying a scan pulse to the plurality of scan electrodes during an address period; and
supplying address pulses, which correspond to the scan pulse and have different supply time point depending on the address electrode groups, to the plurality of address electrodes.

17. The method of claim 16, wherein the width of the address pulse is substantially equal to a width obtained by dividing the width of the scan pulse by the number of address electrodes belonging to each of the plurality of address electrode groups.

18. The method of claim 17, wherein the number of address electrodes belonging to each of the plurality of address electrode groups is equal to two.

19. The method of claim 16, wherein the width of the address pulse is substantially equal to a width obtained by dividing the width of the scan pulse by the number of address electrode groups.

20. The method of claim 19, wherein the number of address electrode groups is equal to two.
